(19) United States
(12) Patent Application Publication
(10) Pub. No.: US 2017/0264725 A1
(43) Pub. Date: Sep. 14, 2017

(54) HANDS-FREE MOUNT FOR MOBILE DEVICES

(71) Applicant: Josh Holder, Westminster, CO (US)

(72) Inventor: Josh Holder, Westminster, CO (US)

(21) Appl. No.: 15/452,342

(22) Filed: Mar. 7, 2017

Related U.S. Application Data
(60) Provisional application No. 62/305,869, filed on Mar. 9, 2016.
(60) Provisional application No. 62/340,732, filed on May 24, 2016.

(51) Int. Cl. H04M 1/11; B60R 11/02; F16B 1/00

(52) U.S. Cl. CPC H04M 1/11; F16B 1/00; B60R 11/0241; F16B 2001/0035; B60R 2011/0033

(57) ABSTRACT

A hands-free mount for a mobile device is disclosed. An example hands-free mount includes a first plate for combining with a case of the mobile device, and a second plate for pairing with the first plate. The second plate is magnetically attachable at least in part to the first plate, and the second plate is attachable at least in part to a surface so that the mobile device can be magnetically attached to the surface. The hands-free mount can be universal to fit all smartphones. It provides a sleek removable magnetic back that can be used with or without a case for numerous mounting options.

### CROSS REFERENCE TO RELATED APPLICATIONS

This application claims the priority benefit of U.S. Provisional Patent Application No. 62/305,869 filed Mar. 9, 2016 for “Hands-Free Mount For Mobile Devices,” and U.S. Provisional Patent Application No. 62/340,732 filed May 24, 2016 for “Hands-Free Mount For Mobile Devices,” each of which is incorporated by reference in its entirety as though fully set forth herein.

### BACKGROUND

The mobile device has become more than simply a phone. Most mobile devices (also called “smart” phones) today are a small and powerful computing device. Even the camera has made exponential leaps in picture quality, making the photos and video taken on a mobile device rival that of other good quality cameras.

However, using the mobile device still requires the user to hold the mobile device while taking a picture or video. The so-called “selfie stick” seeks to address this issue, enabling a user to hold the mobile device far enough away so that the person holding the device can also be a part of the picture. But the user still must hold the camera (i.e., via the selfie stick). As such, the user cannot participate in other activities while taking a photo or video.

### BRIEF DESCRIPTION OF THE DRAWINGS

FIG. 1 shows an example hands-free mount for a mobile device.

FIGS. 2A-B illustrate assembly of the example hands-free mount for a mobile device.

FIGS. 3A-D illustrate operation of the example hands-free mount for a mobile device.

FIGS. 4A-E illustrate example use-cases for the example hands-free mount for a mobile device.

### DETAILED DESCRIPTION

A hands-free mount is disclosed as it may be implemented with a mobile device. The hands-free mount includes a detachable magnetic backing that enables a user to mount their mobile device to any surface (e.g., any metallic or non-metallic surface). In an example, a thin piece of metal is inserted into the back of any case for a mobile device. This can then be paired with a detachable magnetic material. In another example, a thin piece of magnetic material is inserted into the back of the case for the mobile device to make the mobile device magnetic. This can then be paired (e.g., magnetically) with any metal material, including but not limited to a detachable metal plate.

In either example, the detachable backing can be positioned to an object so that the mobile device can be magnetically attached thereto, enabling the mobile device to be attached “hands-free” to any desired location. As such, the hands-free mount turns any mobile device (e.g., smart phone, tablet, or other device) into a body camera, so that the user can record hiking, biking, walking, or other event, hands-free. In addition, the mobile device (or other device) can be attached to other magnetic or non-magnetic surfaces for hands-free mounting. In an example, the hands-free mount enables the user to mount the mobile device without having to hold the mobile device, e.g., to take a photo or video with himself or herself in the photo or video, for use while driving, etc.

Before continuing, it is noted that as used herein, the terms “includes” and “including” mean, but is not limited to, “includes” or “including” and “includes at least” or “including at least.” The term “based on” means “based on” and “based at least in part on.”

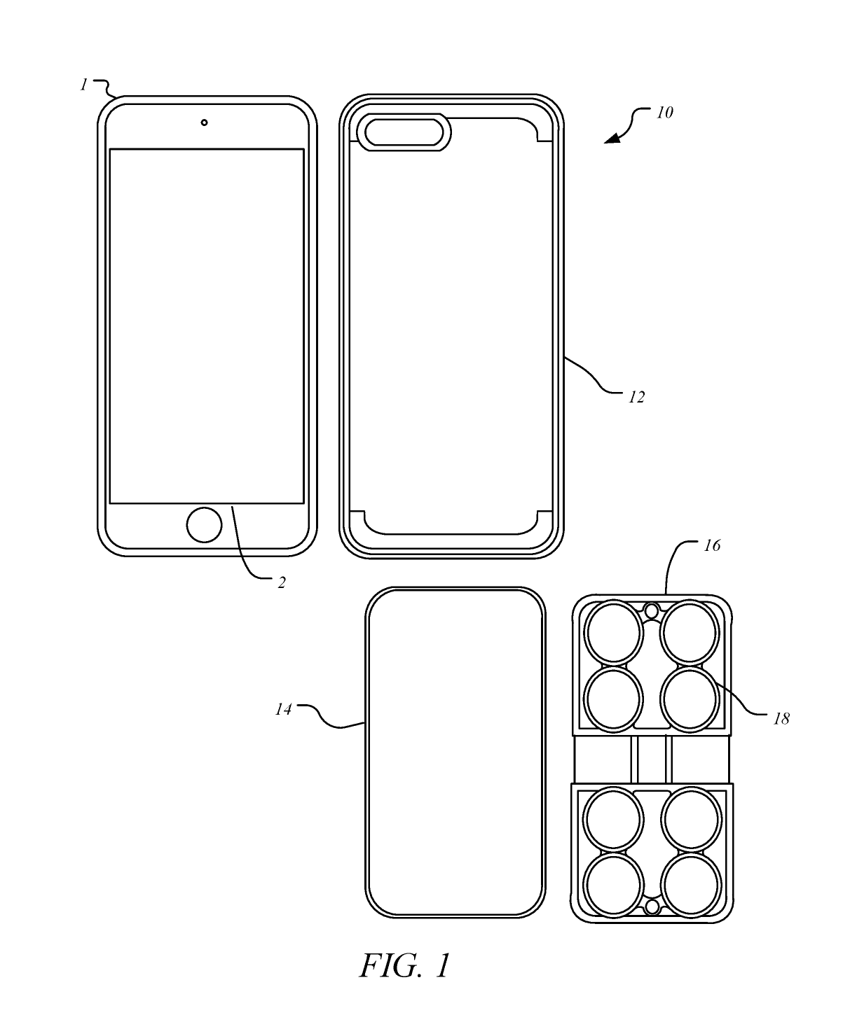

FIG. 1 shows an example hands-free mount 10 for a mobile device 1 having a front 2 and a back 3. An example hands-free mount 10 for a mobile device 1 includes a ferromagnetic plate 14 and a magnetic plate 16 (e.g., having magnets 18). The plates 14 and 16 may be paired to mount the mobile device 1, e.g., for hands-free operation. For example, the plates 14 and 16 may be magnetically attachable at least in part to one another, and one of the plates 14 or 16 may be attachable at least in part to a surface so that the mobile device 1 can be attached to the surface.

It is noted that individual magnets 18 need not be provided. For example, the plate 16 may be a magnet or have a magnetic surface. It is also noted that either plate 14 or plate 16 may be combined with a case 12 of the mobile device 1, or otherwise mounted to the mobile device 1.

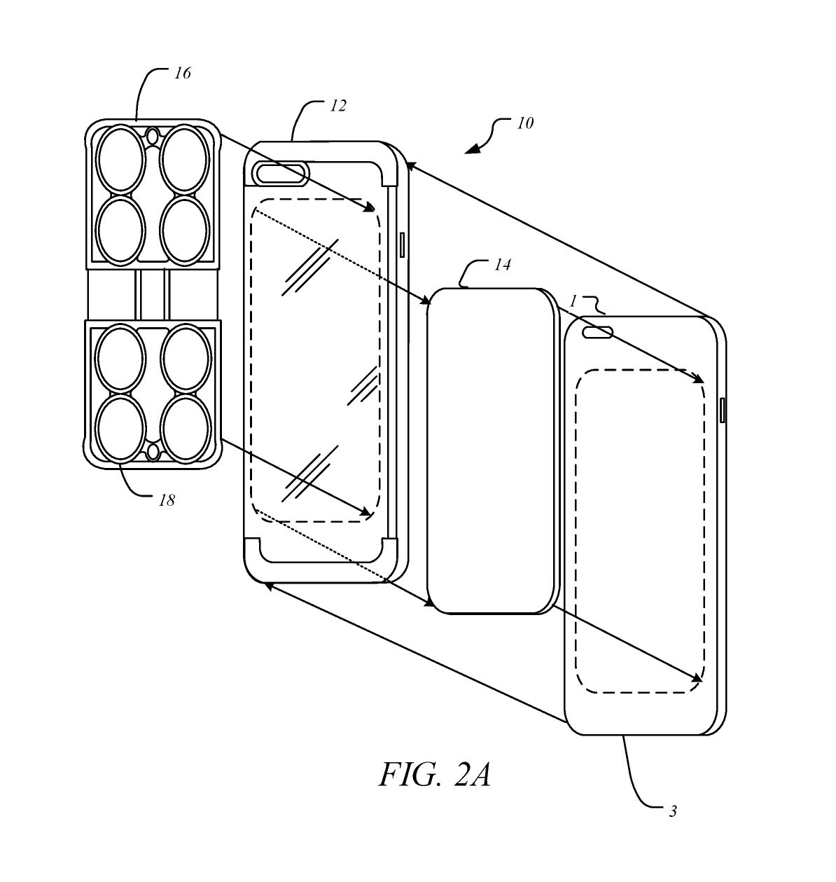

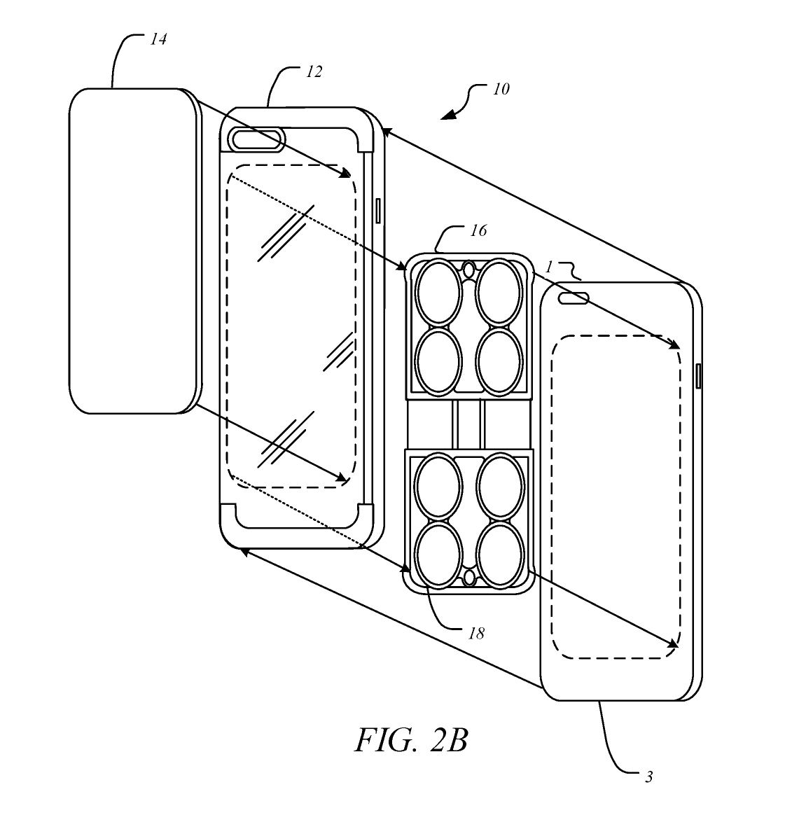

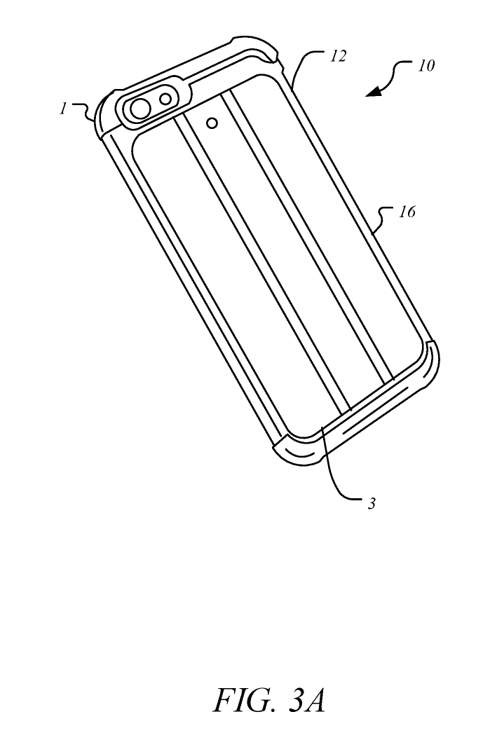

FIGS. 2A-B illustrate assembly of the example hands-free mount 10 for a mobile device 1. In an example, one of the plates 14 or 16 may be paired with the mobile device 1 via a case 12. For example, either of the plates 14 or 16 may be fitted behind the case 12, and attached to the mobile device 1 by attaching the case 12 to the mobile device 1.

FIG. 2A illustrates plate 14 being inserted between the case 12 and the mobile device 1. Plate 16 can be attached to any desired surface and paired with plate 14, thereby mounting the mobile device 1 to the surface.

FIG. 2B illustrates plate 16 being inserted between the case 12 and the mobile device 1. Plate 14 can be attached to any desired surface and paired with plate 16, thereby mounting the mobile device 1 to the surface.

In an example, the case 12 may be an aftermarket case (e.g., a protective case) for the mobile device 1. In another example, the case 12 may be the manufacturer casing of the phone (e.g., a battery cover).

In another example, one of the plates 14 or 16 includes an adhesive surface (e.g., is a “sticker”). As such, the plate (e.g., plate 14) having the adhesive surface can be adhered to the desired mounting surface so that the other plate (e.g., plate 16) can be paired with the adhesive plate and mounted to the surface. This may be desirable, for example, when the mounting surface does not have magnetic properties (e.g., plastic). In this example, the adhesive plate or “sticker” can be adhered to the plastic surface (e.g., the back of a computer monitor as shown in FIGS. 5A and 5B, discussed below), and then the mobile device 1 mounted to the sticker via the magnetic plate 16 on the mobile device 1.

Of course, it is noted that the “sticker” plate can be magnetic or ferromagnetic, and the opposite type of plate (e.g., ferromagnetic or magnetic, respectively) can be implemented on the mobile device 1.

Still other examples are contemplated, as will be readily understood by those having ordinary skill in the art after becoming familiar with the teachings herein. For example, the plate to be attached on the desired mounting surface and/or to the mobile device 1 (e.g., the cover 12) by a clip, clamp, button, snap, or any other suitable attachment, to attach the plate to the mounting surface so that the other plate (i.e., the plate on the mobile device 1) can be paired with the plate on the mounting surface to mount the mobile device 1 to the mounting surface.

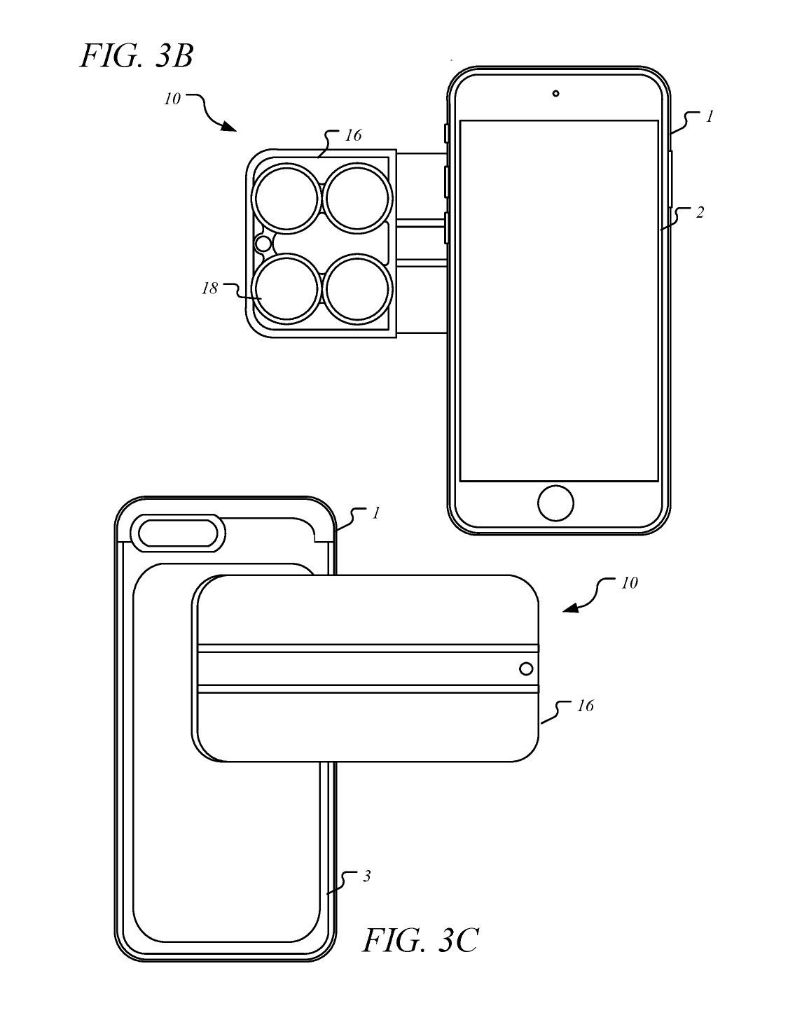

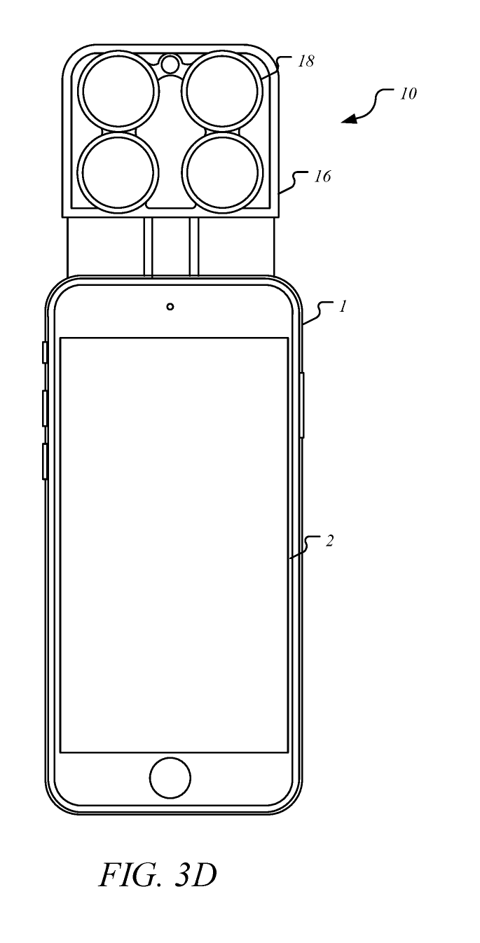

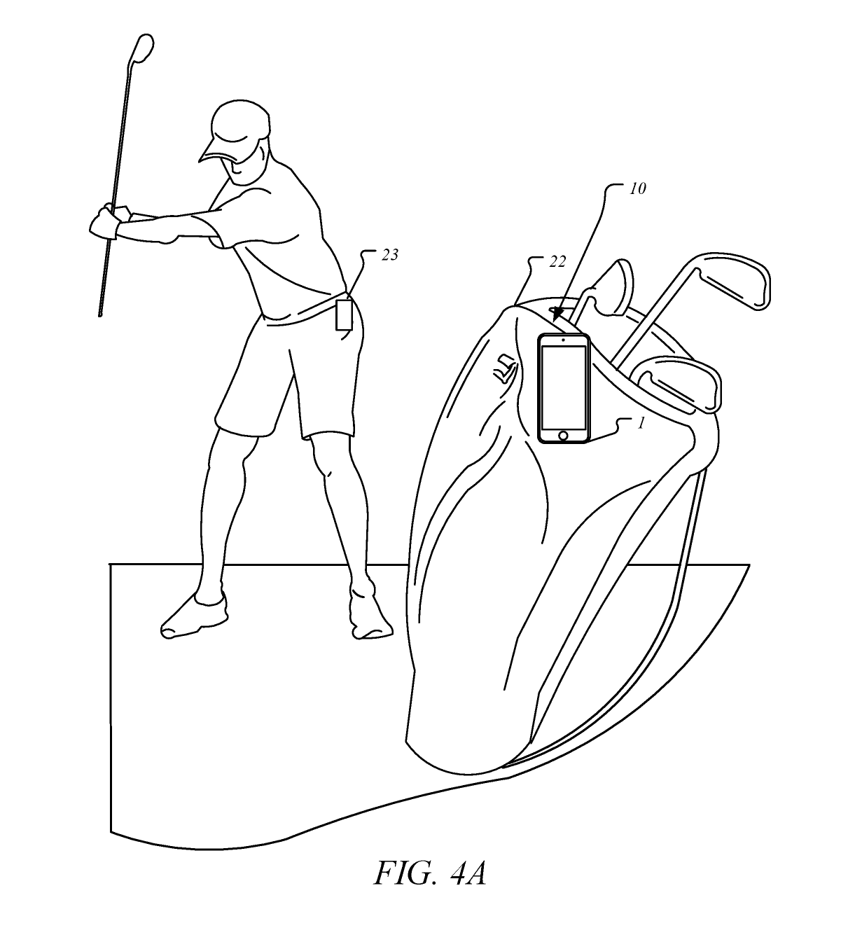

FIGS. 3A-D illustrate operation of the example hands-free mount 10 for a mobile device 1. In an example illustrated by FIGS. 3A-D, ferromagnetic plate 14 is positioned behind the case 12 of the magnet device 1 (and therefore is not visible in FIGS. 3A-D), and the magnetic plate 16 is paired with the plate 14 so that it is removably attached to the outside of the case 12. In another example illustrated by FIGS. 3A-D, the plate 16 may be attached (e.g., pivotally or otherwise attached by button or snap, etc.) to the case 12.

FIGS. 3B-3D illustrate the magnetic plate 16 as it may be rotated to various positions. In FIGS. 3B-C, the magnetic plate 16 is shown rotated to a side position. In FIG. 3D, the magnetic plate 16 is shown rotated to a top position. Although not shown, the magnetic plate 16 may also be rotated to a bottom position (i.e., opposite that shown in FIG. 3D).

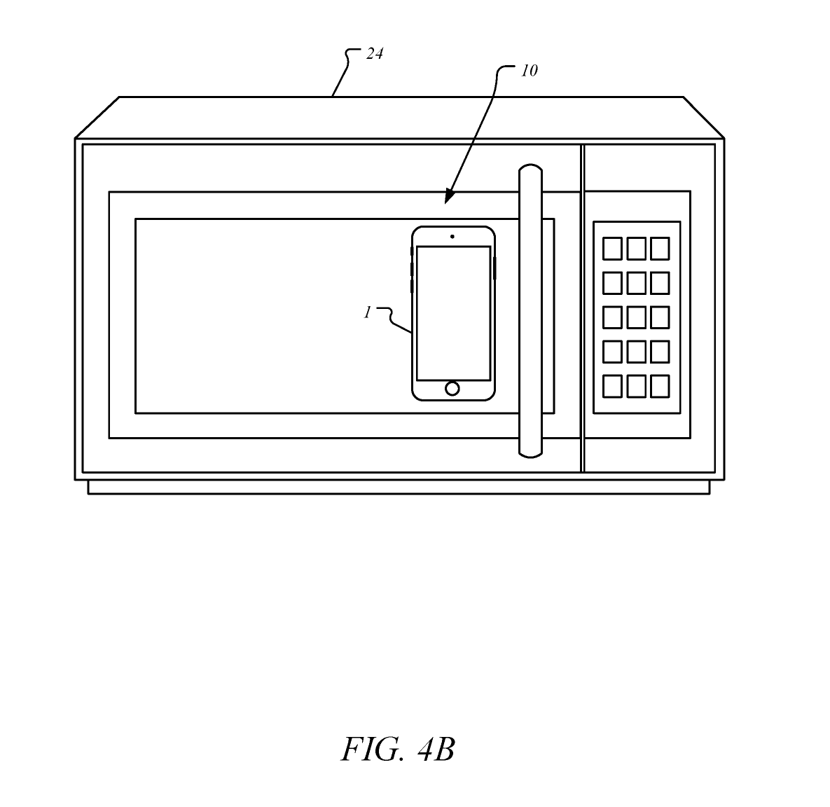

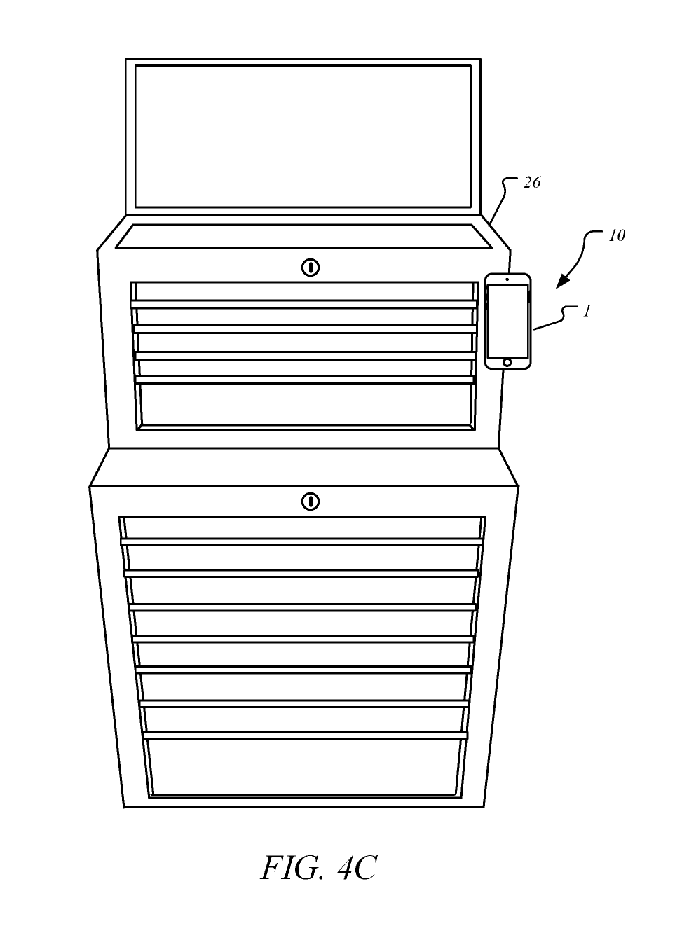

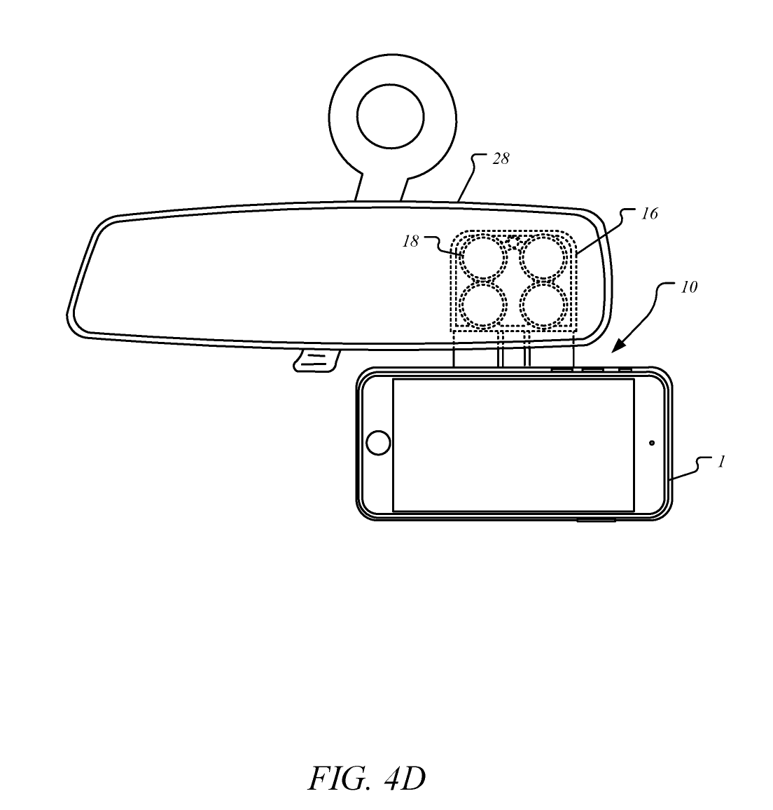

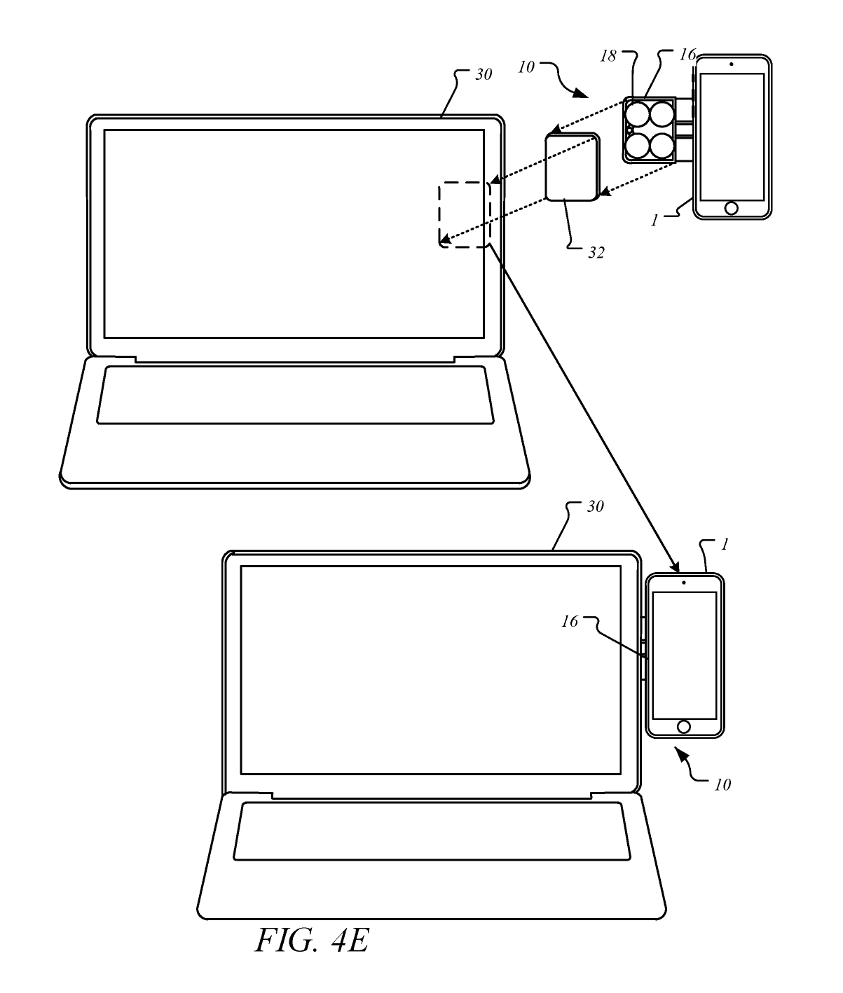

It can be seen from the illustrations in FIGS. 3B-3D that the mobile device 1 can be mounted to a surface by pairing the exposed magnetic surface of plate 16 with a ferromagnetic surface. Examples are illustrated in FIG. 4E, discussed in more detail below.

Before continuing, it should be noted that the examples described above are provided for purposes of illustration, and are not intended to be limiting. Other devices and/or device configurations may be utilized to carry out the operations described herein.

FIGS. 4A-E illustrate example use-cases for the example hands-free mount for a mobile device. It is noted that the operations illustrated in the drawings are not intended to be limiting to any particular use case. Still other operations may also be implemented for any of a wide variety of different use cases.

FIG. 4A shows an example hands-free mount 10 as it may be implemented to mount a mobile device 1 on a bag 22, such as a golf bag (although other bags or purses may also be used). In an example, one of the plates (e.g., magnetic plate 16) is positioned inside the bag 22, and the plates 14 and 16 are magnetically coupled through the bag 22 so that the mobile device 1 can be magnetically attached to the bag 22. This mode of operation may enable “hands-free” operation of the mobile device 1. A remote 23 (wired or wireless such as BLUETOOTH™) may be provided to control the mobile device 1 when the user steps away from the mobile device 1.

FIG. 4B shows an example hands-free mount 10 as it may be implemented to mount a mobile device 1 to a magnetic surface of an appliance 24, such as a microwave or refrigerator. FIG. 4C similarly shows the example hands-free mount 10 as it may be implemented to mount a mobile device 1 to a magnetic surface of a tool box 26. In these examples, the ferromagnetic plate 14 may not be used. Instead, the magnetic plate 16 is provided on the mobile device 1, such as between the cover 12 and the mobile device 1, and the magnetic plate 16 is magnetically coupled to the appliance 24 or tool chest 26 so that the mobile device 1 can be magnetically attached thereto. This mode of operation may enable “hands-free” operation of the mobile device 1.

FIG. 4D shows an example hands-free mount 10 as it may be implemented to mount a mobile device 1 to a rear-view mirror 28 of an automobile. In this example, the ferromagnetic plate 14 may be provided on the mobile device 1, such as between the cover 12 and the mobile device 1, and the magnetic plate 16 is magnetically coupled to in part to the mobile device 1, and in part on the rear-view mirror 28. This mode of operation may enable “hands-free” operation of the mobile device 1, e.g., as a dash camera while driving.

FIG. 4E shows an example hands-free mount 10 as it may be implemented to mount a mobile device 1 to a laptop computer 30. In this example, the ferromagnetic plate 14 may be provided on the laptop computer 30 (e.g., as a metal “sticker” adhered to the monitor with an adhesive). The magnetic plate 16 is magnetically coupled to in part to the mobile device 1, and in part on the sticker to mount the mobile device 1 on or adjacent to the laptop computer 30.

The example use-cases shown in FIGS. 4A-E are illustrative only, and not intended to be limiting. Of course, the example hands-free mount may be implemented with any number of other devices, such as a tablet, television, cash register, etc. with or without a metal backing (e.g., using the magnetic or metal stickers). The example hands-free mount may be implemented for a wide variety of sports and/or other activities. The example hands-free mount may also be implemented on any type of surface, including but not limited to vehicles, boats, ski helmets, etc. with or without a metal backing (e.g., using the magnetic or metal stickers). Still other implementations are also contemplated, as will be readily understood by those having ordinary skill in the art after becoming familiar with the teaching herein.

Likewise, the hands-free mount 10 may be implemented with any of a variety of components. For example, the hands-free mount 10 may be implemented with or without a case 12 for the mobile device 1. For example, the plate may be attached (e.g., via adhesive) to the outside of the mobile device or to the case 12. This may be particularly desirable if the case 12 is thick, for example a LIFE CASE™ or an OTTER BOX™. The plate may also be attached (e.g., via adhesive) directly to the mobile device 1 itself. As such, the hands-free mount works well with any case, and even without a case.

It is noted that the examples shown and described are provided for purposes of illustration and are not intended to be limiting. Still other examples are also contemplated.

1. A hands-free mount for a mobile device, comprising:
a first plate for combining with the mobile device to mount the mobile device on a surface.

2. The hands-free mount of claim 1, further comprising a second plate to pair with the first plate, wherein the first plate is detachable and attachable with the first plate.

3. A hands-free mount for a mobile device, comprising:
a first plate to combine with a case of the mobile device; and
a second plate to pair with the first plate;
wherein the second plate is magnetically detachable and attachable with the first plate.

4. The hands-free mount of claim 3, wherein the first plate has a magnetic material, and the second plate has a ferromagnetic material.

5. The hands-free mount of claim 3, wherein the second plate has a ferromagnetic material, and the first plate has a magnetic material.

6. The hands-free mount of claim 3, wherein the second plate is magnetically attached at least in part to the first plate, and the second plate is magnetically attached at least in part to a surface so that the mobile device can be magnetically attached to the surface.

7. The hands-free mount of claim 3, wherein the second plate is positionable on a surface so that the mobile device can be magnetically attached to the second plate on the surface.

8. The hands-free mount of claim 7, wherein the second plate includes an adhesive to adhere to the surface.

9. The hands-free mount of claim 3, wherein the second plate is positionable behind a surface so that the mobile device can be magnetically attached through the surface to the second plate.

10. The hands-free mount of claim 9, wherein the surface is a non-metallic article, such that the second plate is positioned on or behind the article of so that the mobile device can be magnetically attached to the article.

11. The hands-free mount of claim 3, wherein the first plate is magnetically attached to a surface to attach the mobile device to the surface without the second plate.

12. The hands-free mount of claim 3, further comprising a wireless remote to control the mobile device.

13. The hands-free mount of claim 3, wherein the second plate is a sticker.

14. The hands-free mount of claim 13, wherein the sticker is magnetic.

15. The hands-free mount of claim 13, wherein the sticker is ferromagnetic.

16. A hands-free mount for a mobile device, comprising:
a first plate for combining with a case of the mobile device; and
a second plate for pairing with the first plate;
wherein the second plate is magnetically attachable at least in part to the first plate, and the second plate is attachable at least in part to a surface so that the mobile device can be magnetically attached to the surface.

17. The hands-free mount of claim 16, wherein the surface is a rear-view mirror of an automobile.

18. The hands-free mount of claim 16, wherein the surface is a computer monitor.

19. The hands-free mount of claim 16, wherein the surface is non-magnetic and wherein the second plate is attached to the surface via an adhesive.

20. The hands-free mount of claim 19, wherein the first plate is pivotally mounted to the mobile device.
